(19) United States
(12) Patent Application Publication
(10) Pub. No.: US 2008/0170691 A1
(43) Pub. Date: Jul. 17, 2008

(54) Encryption And Decryption Device In Wireless Portable Internet System,And Method Thereof

(76) Inventors: Sung-Cheol Chang, Daejeon-city (KR); Jae-Sun Cha, Daejeon-city (KR); Seok-Heon Cho, Jeollabuk-do (KR); Chul-Sik Yoon, Daejeon-city (KR)

Correspondence Address: Jefferson IP Law, LLP, 1730 M Street, NW, Suite 807, Washington, DC, 20036, US

(21) Appl. No.: 11/817,864

(22) PCT Filed: Mar. 10, 2006
(86) PCT No.: PCT/KR2006/000865

§ 371 Date: Sep. 5, 2007

(30) Foreign Application Priority Data
Mar. 10, 2005 (KR) 10-2005-0020067

(51) Int. Cl. H04L 9/06; G06F 17/00; H04L 9/28

(52) U.S. Cl. 380/270; 380/28; 380/277

(57) ABSTRACT

The present invention relates to encryption and decryption apparatuses in a wireless portable Internet system, and a method thereof. In the wireless portable Internet system, a subscriber station and a base station share an encryption during key distribution, and a message is encrypted with the encryption key and transmitted. In this case, a first initial vector is generated for encryption based on information shared by the subscriber station and the base station in a wireless channel, and the message is encrypted with the first initial vector and the encryption key and is then transmitted. In addition, a second initial vector for decryption is generated based on information shared by the subscriber station and the base station in the wireless channel, and the encrypted message is decrypted with the second initial vector and the encryption key. Herein, the first initial vector corresponds to the second initial vector.

### TECHNICAL FIELD

The present invention relates to a cryptographic technique in a wireless portable Internet system, and more particularly, relates to encryption/decryption apparatuses for secure transmission/receiving of messages in a wireless portable Internet system, and a method thereof.

### BACKGROUND ART

As next-generation communication technology, wireless portable Internet access further provides mobility to a local data communication system, such as a conventional wireless local area network (LAN), using a stationary access point. There are various standard protocols that have been developed for supporting wireless portable Internet access, and the IEEE 802.16 working group is trying to establish an international standard of wireless portable Internet protocol. The IEEE 802.16 is a specification for a metropolitan area network (MAN) that supports an information communication network in a geographic area or region larger than that covered by a local area network (LAN) but smaller than the area covered by a wide area network (WAN). Particularly, the IEEE 802.16e group announced a specification for a MAN for providing service to a mobile terminal. The Korean Telecommunications Technology Association (TTA) provides wireless portable Internet services by partially selecting functionalities from among the IEEE 802.16d and IEEE 802.16e protocols as a standard of the wireless portable Internet, so-called WiBro.

Such a wireless portable Internet system provides various services to a user, and messages are encrypted before being transmitted or received in order to protect information from third-party interception or system disturbance. That is, a base station or a terminal transmits a message or data to a receiving side by using a predetermined resource, and the receiving side decrypts the message or data. Herein, a message or data to be encrypted for protection is called a plaintext, and the encrypted plaintext is called a ciphertext. The process for converting a plaintext into a ciphertext is called encryption and the process for converting a ciphertext into a plaintext is called decryption.

An encryption algorithm used in a wireless portable Internet system basically encrypts an encryption target (i.e., a message and data) block by block. A block encryption algorithm is an algorithm for transforming an input block with a fixed length into an output block with a fixed length by using an encryption key, and every bit of the output block is influenced by every bit of the input block and every bit of the key. As a conventional block encryption algorithm, a data encryption standard (DES) that uses a 56-bit key was developed, and an advanced encryption standard using a 128-bit key has been introduced to compensate the stability of the DES.

A block of 64-bit or 128-bit text is encrypted and decrypted according to such a block encryption algorithm, and therefore a plurality of blocks must be processed for typical data encryption/decryption. At this time, a method for setting a relationship or dependency between each block is called a mode, and an electronic code book (ECB) mode, a cipher block chaining (CBC) mode, a counter with CBC-MAC (CCM) mode, and a counter (CTR) mode are commonly used. Each mode is applied with appropriate consideration of its merits and drawbacks in order to increase cryptographic security.

In the ECB mode, each block is encrypted and decrypted independently of any other block in the simplest way and thus it has a drawback of reducing cryptographic security. Accordingly, the CBC mode, the CCM mode, the CTR mode are commonly used in order to increase the cryptographic security, and each mode uses a predetermined initial vector for each data unit to be encrypted. That is, a different initial vector is used for every message, and a transmitting side that transmits an encrypted message and a receiving side that receives the encrypted message use the same initial vector for different messages for encryption and decryption, respectively.

Thus, a field for transmitting an initial vector is added to a message to be transmitted. In more detail, in the CCM mode or CRT mode of an AES block algorithm, a 4-byte field is added to a message to be transmitted and an initial vector is recorded in the field. However, when the size of the message is relatively small, adding a field to a message may have the drawback of reducing data efficiency. In addition, bandwidth usage efficiency may also be reduced.

Meanwhile, in the CBC mode of a DES block algorithm, an initial vector that has been exchanged during key distribution is used for encryption. That is, a CBC initial vector (IV) is used for the encryption. In more detail, a block is encrypted on the basis of a resultant value of an Exclusive-OR (XOR) operation between a CBC IV and a physical layer (PHY) frame value for each frame. Since a medium access control (MAC) protocol data unit (PDU) is transmitted through an allocated resource of each frame, a value of an initial vector should be changed for each MAC PDU to satisfy the cryptographic security required in the CBC mode. Because the frame number repeates periodically, each frame's number has a different resultant value of the XOR operation within a period. However, the periodicity of the frame number prevents every frame from having a different frame value and it may be possible for every MAC PDU not to have a different initial vector, thereby degrading cryptographic performance.

The above information disclosed in this Background section is only for enhancement of understanding of the background of the invention and therefore it may contain information that does not form the prior art that is already known in this country to a person of ordinary skill in the art.

### DISCLOSURE

### Technical Problem

In order to solve the above-described problems, the present invention has been made in an effort to provide encryption and decryption apparatuses for encrypting and decrypting a message by using an initial vector that can be generated by a message transmitting side and a message receiving side in a wireless portable Internet system even though information for encryption is not additionally transmitted when transmitting/receiving the message, and a method thereof.

In addition, the encryption and decryption apparatuses generate the same initial vectors for encryption and decryption based on information of each message to thereby respectively perform encryption and decryption according to the present invention.

In addition, an initial vector that can satisfy requirements for maintaining cryptographic security can be generated by changing an input value of each message during the encryption and decryption processes without adding a random nonce field to each message, according to the present invention.

In addition, an initial vector that can satisfy requirements for maintaining cryptographic security while minimizing the size of a random nonce field that is added for each message can be generated according to the present invention.

### Technical Solution

An exemplary embodiment of the present invention provides a method for generating an initial vector for encryption/decryption of a message transmitted/received between a subscriber station and a base station in a wireless portable Internet system. The subscriber station and the base station share an encryption key during key distribution. The method includes a) obtaining first information shared by the subscriber station and the base station in a wireless channel; b) extracting predetermined second information from the message; and c) generating the initial vector on the basis of the first and second information.

Another exemplary embodiment of the present invention provides a method for generating an initial vector required for encryption/decryption of a message transmitted/received between a subscriber station and a base station in a wireless portable Internet system. The subscriber station and the base station share an encryption key during key distribution. The method includes a) determining a frame number that is broadcast for each frame; b) determining header information by extracting a header from the message; c) determining an identifier of the subscriber station; and d) generating an initial vector for encryption on the basis of the frame number, the header information, and the identifier.

In this case, the subscriber station and the base station may additionally share a fixed initial vector. In addition, d) may include obtaining an initial vector plaintext by executing a logical operation between 1) the frame number, the header information, and the identifier and 2) the fixed initial vector, and generating the initial vector by processing the initial vector plaintext with the encryption key.

Another exemplary embodiment of the present invention provides a method for generating an initial vector for encryption/decryption of a message transmitted/received between a subscriber station and a base station in a wireless portable Internet system. The subscriber station and the base station share an encryption key during key distribution. The method includes a) determining a frame number that is broadcast for each frame; b) determining header information by extracting a header from the message; c) determining an identifier for the subscriber station; d) determining a count value that represents the number of zero hit times of the frame number; e) generating an initial vector for encryption based on the frame number, the header information, the identifier, and the count value.

In this case, the subscriber station and the base station may additionally share a fixed initial vector during key distribution. In addition, e) may include obtaining an operation resultant value by executing a logical operation between the identifier and the count value; obtaining an initial vector plaintext by executing a logical operation between 1) the frame number, the header information, and the operation resultant value and 2) the fixed initial vector; and generating the initial vector by processing the initial vector plaintext with the encryption key.

A further exemplary embodiment of the present invention provides an encryption apparatus for encrypting a message transmitted/received between a subscriber station and a base station in a wireless portable Internet system. The subscriber station and the base station share an encryption key during key distribution. The encryption apparatus includes an initial vector generator for generating an initial vector for encryption of the message based on information shared by the subscriber station and the base station, and an encryption unit for encrypting the message with the initial vector and the encryption key.

Still another exemplary embodiment of the present invention provides a decryption apparatus for decrypting a message transmitted/received in a wireless portable Internet system. The subscriber station and the base station share an encryption key during key distribution. The decryption apparatus includes an initial vector for generating an initial vector for decryption of the message based on information shared by the subscriber station and the base station in a wireless channel, and a decryption unit for decrypting the message with the initial vector and the encryption key. The generated initial vector equals an initial vector that has been used for encryption of the message.

### DESCRIPTION OF DRAWINGS

FIG. 1 is a schematic diagram illustrating a structure of a wireless portable Internet system according to an exemplary embodiment of the present invention.

FIG. 2 shows a structure of an encryption and decryption apparatus according to an exemplary embodiment of the present invention.

FIG. 3 shows an overall encryption and decryption process according to an exemplary embodiment of the present invention.

FIG. 4 is a configuration diagram of an initial vector generator according to a first exemplary embodiment of the present invention.

FIG. 5 is a configuration diagram of a medium access control (MAC) PDU according to an exemplary embodiment of the present invention.

FIG. 6 is a flowchart of a process of generating an initial vector according to the first exemplary embodiment of the present invention.

FIG. 7 is an exemplary diagram schematically illustrating the process of FIG. 6.

FIG. 8 is a configuration diagram of an initial vector generator according to a second exemplary embodiment of the present invention.

FIG. 9 exemplarily shows an operation state of a zero hit counter according to an exemplary embodiment of the present invention.

FIG. 10 is a flowchart illustrating a process of generating an initial vector according to the second exemplary embodiment of the present invention.

FIG. 11 is an exemplary diagram schematically illustrating the process of FIG. 10.

FIG. 12 is a configuration diagram of an initial vector generator according to a third exemplary embodiment of the present invention.

FIG. 13 exemplarily shows an operation relationship between a zero cycle number and a zero hit counter according to an exemplary embodiment of the present invention.

FIG. 14 is a flowchart illustrating a process of generating an initial vector according to the third exemplary embodiment of the present invention.

FIG. 15 is a flowchart illustrating a process of generating an initial vector according to a fourth exemplary embodiment of the present invention.

### BEST MODE

Exemplary embodiments of the present invention will hereinafter be described in detail with reference to the accompanying drawings.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive.

Throughout this specification and the claims which follow, unless explicitly described to the contrary, the word “comprise” or variations such as “comprises” or “comprising” will be understood to imply the inclusion of stated elements but not the exclusion of any other elements.

In addition, throughout this specification and the claims which follow, a module means a unit that performs a specific function or operation, and can be realized by hardware or software, or a combination of both.

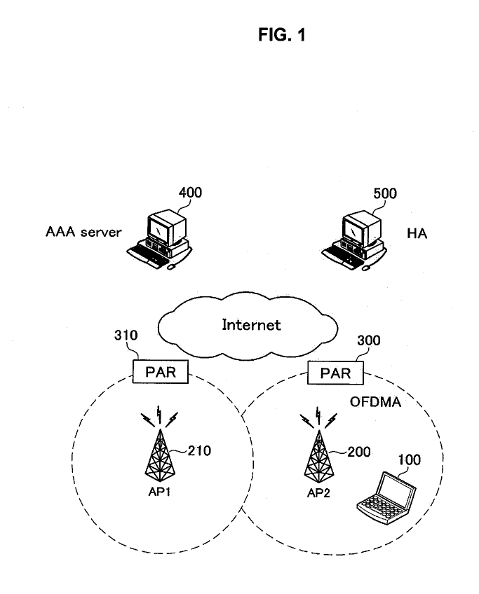

FIG. 1 is a schematic diagram illustrating a structure of a wireless portable Internet system according to an exemplary embodiment of the present invention.

A wireless portable Internet system basically includes a subscriber station 100, base stations 200 and 210 (for ease of description, the reference number “200” will be used as a representative reference number for the base stations), packet access routers (PAR) 300 and 310 (for ease of description, the reference number “300” will be used as a representative reference number for the packet access routers) connected with the base station 200, and an authentication authorization accounting (AAA) server 400 for authorizing the subscriber station 100. The wireless portable Internet system may further include a home agent (HA) 500 for registering information on the subscriber station 100.

A base station, for example, is located in a metropolitan area and a PAR manages a plurality of subscriber stations such that a hierarchical structure is formed.

With this configuration, the subscriber station 100, the base station 200, and the PAR 300 perform ranging, basic capability negotiation, authorization, registration, hand-off, and traffic connection establishment by inter-working with each other in the wireless portable Internet system. Thus, the base station 200 processes a signal transmitted from the subscriber station 100 or the PAR 300 and transmits the processed signal to the PAR 300 or the subscriber station 100, and the PAR 300 manages a plurality of base stations 200 for hand-off control and mobile IP.

The subscriber station 100 and the base station 200 start to communicate with each other to negotiate an authorization mode and authorize the subscriber station 100 according to the selected mode.

In a wireless portable Internet system having such features, the encryption and decryption apparatuses according to the exemplary embodiment of the present invention encrypt or decrypt a message based on a key that maintains a predetermined value during encryption or decryption and an initial vector that is changed in accordance with a message type. Herein, the message includes all types of messages that contain data and can be transmitted and received in a wireless portable Internet system.

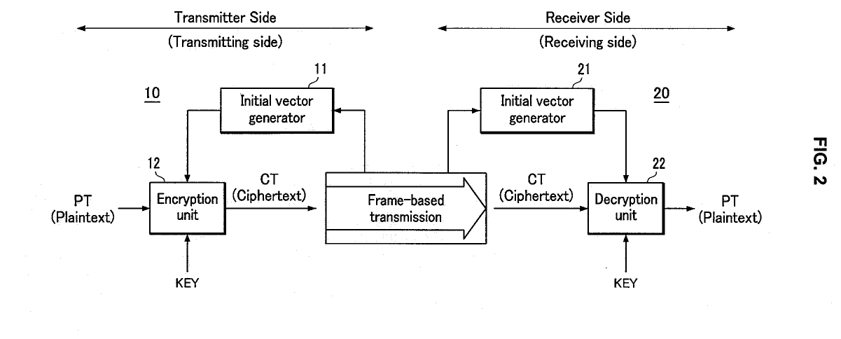

FIG. 2 is a configuration diagram of an encryption and decryption apparatus according to an exemplary embodiment of the present invention.

As shown in FIG. 2, an encryption apparatus 10 according to the exemplary embodiment of the present invention includes an initial vector generator 11 and an encryption unit 12, and transforms an input plaintext (PT) into a ciphertext (CT) and outputs the CT.

In the CBC mode, the encryption unit 12 encrypts each block of PT. Herein, each block is XORed with an initial vector before being encrypted and the XORed value is encrypted with an encryption key according to the exemplary embodiment of the present invention. The next block of PT is XORed with the previous block of PT before being encrypted and is then encrypted on the basis of the encryption key. However, the above-described encryption method is not restricted to the CBC mode. It may be applied to other encryption modes that use an initial vector for encryption.

Meanwhile, the decryption apparatus 20 includes an initial vector generator 21 and a decryption unit 22, and receives a CT transmitted on a frame basis and converts the received CT into a PT. At this time, the initial vector generator 21 generates an initial vector that is the same as the initial vector that has been used for encryption of the received CT, and the decryption unit 22 decrypts an input CT into its original PT based on an encryption key and an initial vector. The encryption key is maintained the same during the decryption and the initial vector is different for each different PT.

The initial vector generators 11 and 21 used in the encryption apparatus 10 and the decryption apparatus 20 respectively generate an initial vector by using frame information that is shared by the base station 200 and the subscriber station 100 in a wireless access network. The information includes a frame number.

Based on such a structure, an encryption and decryption method according to an exemplary embodiment of the present invention will be described.

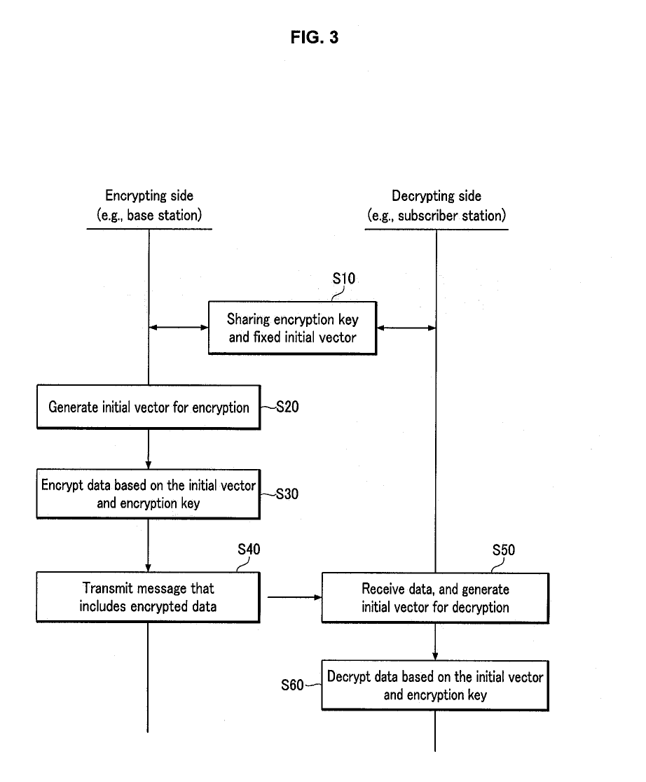

FIG. 3 is a flowchart illustrating an overall encryption and decryption method according an exemplary embodiment of the present invention. It is exemplarily depicted in FIG. 3 that a base station 200 is a transmitting side so that it encrypts a message and transmits the encrypted message, and a subscriber station 100 is a receiving side so that it receives the encrypted message and decrypts the same, but it is not restrictive.

After a connection is established between the subscriber station 100 and the base station 200 and an authorization process is performed, the subscriber station 100 and the base station 200 share a traffic encryption key (TEK) during a key distribution process. The TEK is an encryption key that is maintained the same during an encryption process. In addition, the base station 200 and the subscriber station 100 share a fixed initial vector that is used for block encryption during the key distribution process in step S10. The initial vector is fixed to a value that is shared by the subscriber station 100 and the base station 200 during the key distribution process. Since this initial vector shared by the base station 200 and the subscriber station 100 is different from an initial vector that is generated by the encryption and decryption apparatuses 10 and 20 during encryption and decryption, the initial vector shared by the base station 200 and subscriber station 100 during the key distribution process is called a “fixed initial vector” and the initial vectors respectively generated for each message by the encryption and decryption apparatuses 10 and 20 are called “random initial vectors.”

The subscriber station 100 and the base station 200 respectively encrypt a message and transmit the encrypted message or receive the encrypted message and decrypt the same with an encryption key (i.e., TEK) that has been shared by the subscriber station 100 and the base station 200 during the key distribution process.

In more detail, as shown in FIG. 3, when the transmitting side, for example the base station 200, attempts to transmit a message, the initial vector generator 11 of the encryption apparatus 10 generates a different initial vector for each different message. That is, the initial vector generator 11 generates a random initial vector, in step S20. Particularly, the initial vector generator 11 generates the encryption initial vector by using frame information that includes a frame number and is shared by the base station 200 and the subscriber station 100 in the wireless access link.

Subsequently, the encryption unit 12 encrypts a PT message input thereto on the basis of the encryption key that is maintained the same during the encryption process and the random initial vector, and transmits the encrypted message in steps S30 and S40.

Meanwhile, the receiving side, for example the decryption apparatus 20 of the subscriber station 100, that has received the encrypted message, which is a message containing a CT, generates a random initial value corresponding to the received message by using the information shared by the base station 200, in step S50. The random initial vector generated by the decryption apparatus 20 has the same value as the random initial vector generated during the encryption process in the base station 200.

Next, the decryption unit 22 decrypts the CT included in the message with the random initial vector generated for the message and an encryption key that is maintained the same during the decryption process, in step S60.

Therefore, an initial vector for encryption or decryption may not need to be additionally transmitted when transmitting a message since the transmitting side and the receiving side can generate an initial vector for encrypting or decrypting the message on the basis of information shared by both sides according to the above-described embodiment of the present invention.

A method for generating an initial vector for encryption and decryption according to an exemplary embodiment of the present invention will now be described in more detail.

First, a method for generating an initial vector for encryption and decryption according to a first exemplary embodiment of the present invention will be described. A random initial vector for encryption and decryption is generated on the basis of predetermined information in a message header and information on a frame by which a corresponding message is transmitted according to the first exemplary embodiment of the present invention. In this case, an identifier of an object of the message is selectively used when generating the random initial vector.

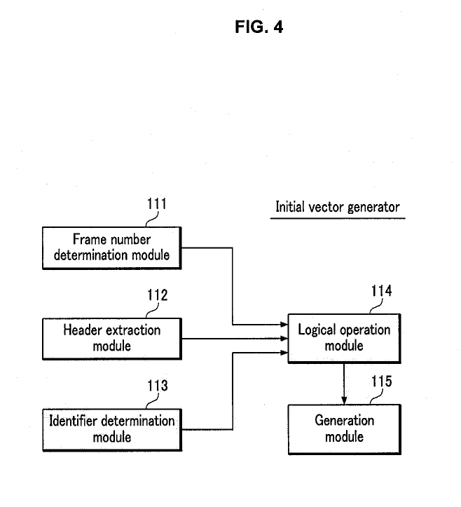

FIG. 4 is a configuration diagram of an initial vector generator 11 and 21 according to the first exemplary embodiment of the present invention.

As shown in FIG. 4, the initial vector generator 11 and 21 includes a frame number determination module 111 for determining information (i.e., frame number) on a frame of a transmitted message, a header extraction module 112 for extracting a header portion of an input message, an identifier determination module 113 for determining an identifier for an object of the message, a logic operation module 114 for carrying out a logic operation between 1) a fixed initial vector obtained during the key distribution process and 2) the extracted header information, the frame number, and the identifier and outputting a resultant value of the operation as a PT so as to generate a random initial vector, and a generation module 115 for generating a random initial vector by processing the PT with an encryption key.

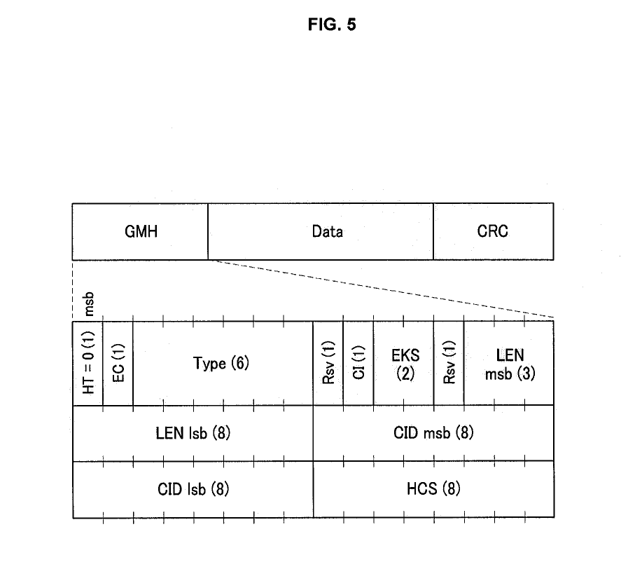

When messages are processed PDU by PDU with addition of a header and a trailer and then transmitted to a MAC layer, and each PDU forms a MAC frame in the MAC layer and is then transmitted. FIG. 5 illustrates a structure of a MAC PDU. As shown in FIG. 5, a MAC PDU includes a generic message header (GMH) field, a data (i.e., payload) field, and a cyclic redundancy check (CRC) field for checking errors.

The GMH field includes message-related information such as a type field for representing the type of a message, a length (i.e., logical block number, LBN) field, a header check sum (HCS) field, and a connection identifier (CID) field.

The length field for example may have a length of 2 bytes, and stores information on a length of a PDU. Each PDU has a different length, and the receiving side can check a data size based on the length information.

The HCS field for example may have a length of 1 byte, and checks errors in a header. The receiving side checks validity of a header based on the information stored in the HCS field and processes a received PDU based on information stored in the header.

The length of the GMH field is, for example, fixed to 6 bytes, but configuration of each field of the GMH depends on its usage. FIG. 5 shows a header of a general message. Among the fields of the GMH field used in the present exemplary embodiment, the length field and the HCS field each has a high possibility of having different values for a different PDU. Therefore, a random initial vector is generated by using the values of the length field and the HCS field that are shared by the base station and the subscriber station and changed for each message according to the exemplary embodiment of the present invention. However, a value of another field of the GMH field can also be used. That is, a value recorded in at least one of fields that form the GMH field can be used as information for generating the random initial vector.

The header extraction module 112 extracts a message header, that is, a GMH field from a MAC PDU, and provides information on the extracted GMH field (i.e., information on a length field and a HCS field) to the logic operation module 114.

The frame number determination module 111 determines information on a PHY synchronization (SYN) field of a MAC frame that corresponds to the message, and provides the corresponding information to the logic operation module 114. The PHY SYN field stores a value for frame synchronization and the value is changed for each frame and is then broadcast. Such a value of the PHY SYN field will be referred to as a “frame number” for ease of description. The frame number may be sequentially increased or decreased. Three bytes of the PHY SYN field represent a frame number, and one byte of the PHY SYN field represents a length of the corresponding frame.

The identifier determination module 113 is an identifier for an object of a corresponding message. According to the exemplary embodiment of the present invention, a MAC address of a subscriber station is used as an identifier for encryption and decryption of a message, but it is not necessarily restricted thereto.

The logic operation module 114 executes a logic operation on the GMH field information, a frame number stored in the PHY SYN field, and the identifier (i.e., a MAC address of the subscriber station) and outputs a resultant value of the operation. In more detail, the logic operation module 114 XORs 1) the GMH field information, the frame number, and the MAC address of the subscriber station with 2) the fixed initial vector, and outputs a resultant value. According to the present embodiment, the logic operation module 114 XORs 1) the frame number and the MAC address of the subscriber station with 2) the fixed initial vector, but it is not restrictive. The logic operation module 114 can also XOR the frame number with the fixed initial vector and output a resultant value.

The generation module 115 processes the resultant value provided from the logic operation module 114 by using a predetermined key, that is, an encryption key, and outputs a resultant value as a random initial vector (IV).

In the following description, a method for generating an initial vector by using an initial vector generator formed with the above-described configuration according to the first exemplary embodiment of the present invention will be described.

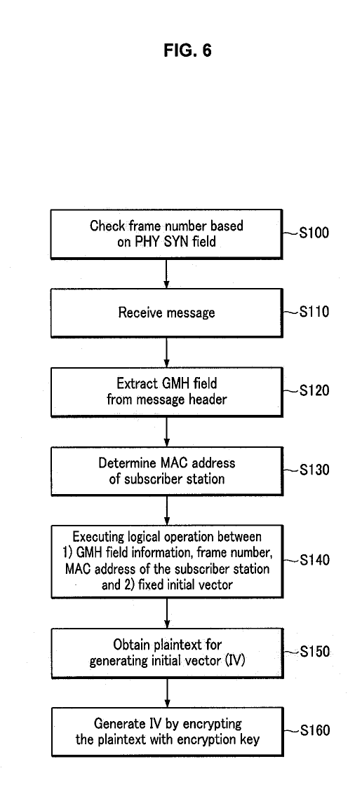

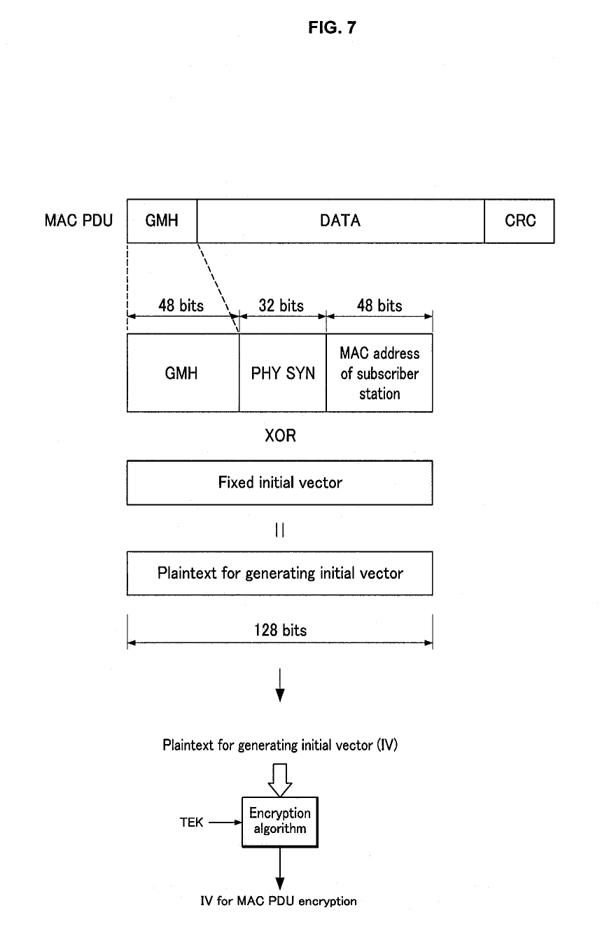

FIG. 6 is a flowchart illustrating a process for generating an initial vector according to an exemplary embodiment of the present invention, and FIG. 7 exemplarily illustrates the process of FIG. 6.

When a base station or a subscriber station wants to encrypt a message for transmission, the message is processed MAC PDU by MAC PDU and a GMH field is added to each MAC PDU. The MAC PDU processed in this manner is input to the encryption apparatus 10 as shown in FIG. 2. Such a MAC PDU will be referred to as an “input message” and data of the MAC PDU will be referred to as an “input plaintext” in the following description.

The initial vector generator 11 of the encryption apparatus 10 generates an initial vector for the input message. In more detail, as shown in FIG. 6 and FIG. 7, the initial vector generator 11 determines a frame number of a frame that is to transmit the PDU from the PHY SYN field in step S100, extracts a GMH field from a header of the input message, and determines a MAC address of a subscriber station that corresponds to the input message in steps S110 to S130. In addition, frame information (i.e., GMH field information, the frame number, and the MAC address of the subscriber station) and the fixed initial vector are XORed and a resultant value is output in the form of a plaintext, that is, an initial vector plaintext, for generating an initial vector in steps S140 and S150 (see FIG. 7). Meanwhile, among the frame information, the GMH field and the frame number, excluding the identifier (i.e., MAC address) of the subscriber station, can only be XORed with the fixed initial vector and the XORed value can be used as a plaintext for generating an initial vector.

This initial vector plaintext may be used as an initial vector IV for encryption. However, in the present exemplary embodiment, the initial vector plaintext is encrypted with a TEK by applying the block encryption algorithm and an encrypted result is used as an initial vector IV for encryption rather than using the initial vector plaintext as it is, in step S160. The AES algorithm is used as the block encryption algorithm, but it is not restrictive.

The initial vector IV generated in the above-describer manner is input to the encryption unit 12, and the encryption unit 12 encrypts an encryption object, that is, an input plaintext of an input message, by using the input initial vector IV and the TEK and outputs the encryption result.

The input message including the plaintext that has been encrypted and output in such a way is processed MAC frame by MAC frame and then transmitted, and frame information (i.e., frame number and a subscriber station identifier) is stored in a header of the corresponding MAC frame.

The receiving side receives such a MAC frame and transmits the same to the decryption apparatus 20. The initial vector generator 21 of the decryption apparatus 20 extracts a PHY SYN field from the received frame, and determines a frame number and a destination address based on the extracted PHY SYN field. Then the initial vector generator 21 extracts a GMH field of the input message included in the received frame. Subsequently, similar to the initial vector generating process in the above-described encryption process, frame information (i.e., frame number, destination address, and GMH field) and the fixed initial vector are XORed and a resultant value of the XOR is encrypted with a TEK such that a value of an initial vector for decryption is generated. In this case, although an initial vector that has been used for the encryption process is not included in the transmitted frame, an initial vector having the same value of the initial vector that has been used for the encryption process can be generated based on the frame information. Therefore, a decryption process is performed on the basis of the initial vector having the same value of the initial vector that has been used during the encryption process.

According to the first exemplary embodiment of the present invention, the encryption side and the decryption side generate initial vectors having the same value and carry out encryption and decryption processes based on the initial vectors even though the initial vector for the decryption is not included in the transmitted frame, thereby achieving stable encryption while significantly reducing a length of a transmit frame.

In addition, since the initial vector is generated on the basis of values (e.g., GMH field and PHY SYN field) that may be changed for each PDU, the initial vector may also be changed for each message, thereby satisfying cryptographic security required in a given encryption mode (e.g., CBC mode).

A method for generating initial vectors for an encryption apparatus and a decryption apparatus according to a second exemplary embodiment of the present invention will be described. In the following description, functions that are the same as the functions of the first exemplary embodiment or elements of the functions will not be further described.

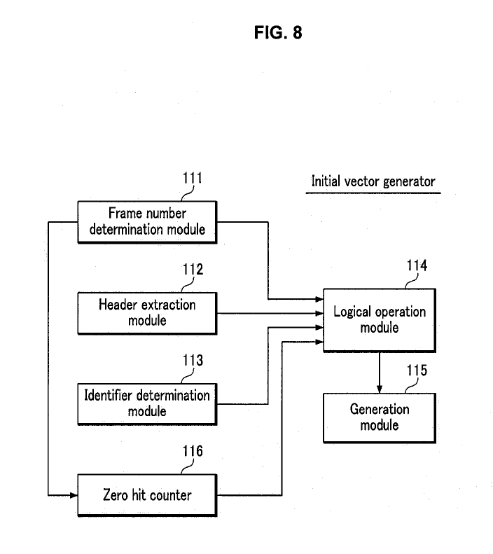

FIG. 8 is a configuration diagram of an initial vector generator according to the second exemplary embodiment of the present invention.

As shown in FIG. 8, the initial vector generators 11 and 21 according to the second exemplary embodiment of the present invention include the same elements as the initial vector generator in the first exemplary embodiment, which are a frame number determination module 111, a header extraction module 112, an identifier determination module 113, a logic operation module 114, and a generation module 115. However, differing from the first exemplary embodiment of the present invention, the initial vector generators 11 and 21 according to the secondary exemplary embodiment further include a zero hit counter (ZHC) 116 for compensating a frame number. The ZHC 116 is a counter that is sequentially incremented for each frame and indicates how many times a value of a PHY SYN field that is broadcast through each frame is initialized to zero in the wireless access link.

In general, a frame number is set, for example, within the range of 0 to M (M>=1, M is a natural number), and iteratively used within the range. That is, the frame number is initialized to zero and to M after being sequentially incremented from zero to M, and therefore the frame number is initialized to zero at every predetermined interval. Such an initialization of the frame number to zero is called “zero hit.”

When a variation of the frame number between 0 and M is defined to be a frame cycle, the frame number has the same value when the frame number is zero hit at a predetermined point, that is, at every frame cycle. Therefore, when an IV is generated on the basis of such a frame number, the same IV may be generated.

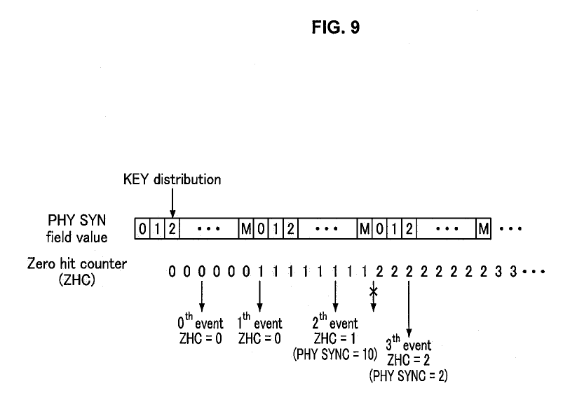

Therefore, according to the second exemplary embodiment of the present invention, how many times a value is sequentially incremented at every frame is counted by the ZHC. That is, how many times that a value of a PHY SYN field that has been broadcast in the wireless access link is initialized to zero is counted by using the ZHC. Therefore, a count value of the ZHC 116 is changed every time the zero hit occurs. FIG. 9 exemplarily illustrates an operation process of the ZHC according to the second exemplary embodiment of the present invention. The ZHC 116, as shown in FIG. 9, is initialized to zero at a point of the key distribution, and a count value of the ZHC 116 increases by one when the value of PHY SYN field, which is arbitrary in the range of 0 to M, is initialized to zero.

A concept of such a ZHC may be applied to the PHY SYN field as well as various objects which have a value of zero. That is, the ZHC indicates the number of times that an object field is initialized to zero. In particular, when the object field sequentially increases, a math figure that calculates the count value of the ZHC at i, that is an event that satisfies a predetermined criterion, may be used rather than calculating the count value of the ZHC at every increment. A result of calculating the count value of the ZHC at every increment has the same result of calculating that of the ZHC at i.

Assume that a value of the object field at an event i is N(i) and a count value of the ZHC is ZHC(i). In this assumption, the count value of the ZHC is calculated by using Math Figure 1.

ZHC(i)=ZHC(i−1)+1 if N(i)<N(i−1) [Math Figure 1]

An event for calculating the count value of the ZHC can be divided into two events. One is an event that the object field is initialized to 0, and the other is an event of receiving a message. The event that the object field is initialized to zero typically satisfies all criteria for increasing the zero hit counter. However, for the receiving side (i.e., the subscriber station) that receives the object field that has been broadcast in the wireless access channel, the count value of the ZHC may be calculated at the time of receiving a message in order to compensate a loss of the case where the object field is initialized to zero.

FIG. 9 illustrates a PHY SYN field as an object field. In FIG. 9, the subscriber station secondly receives a frame having the PHY SYN field value of “0,” and looses the next frame with a PHY SYN field value of “0”. In this case, the subscriber station applies a value of the PHY SYN field to Math Figure 1 at a message receiving event (i.e., 3th event) to thereby increase the count value of the ZHC.

As described, a count value can be obtained by counting every time the object field, that is, the broadcasted PHY SYN field, is initialized to 0 by using the ZHC, or can be generated at every message receiving event by using Math Figure 1 according to the second exemplary embodiment of the present invention, and the count value is used for generating an initial vector for encryption.

Meanwhile, the initial vector generator generates an initial vector on the basis of the count value of the ZHC in addition to frame information (i.e., GMH field information, frame number, and MAC address of the subscriber station) to thereby generate a different initial vector for each different PDU.

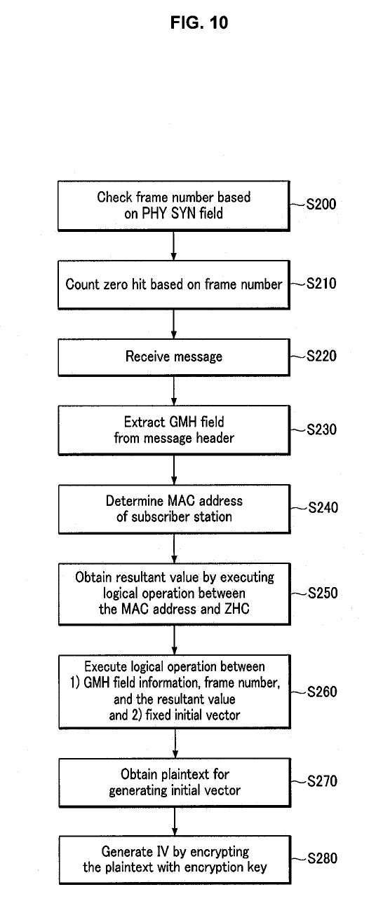

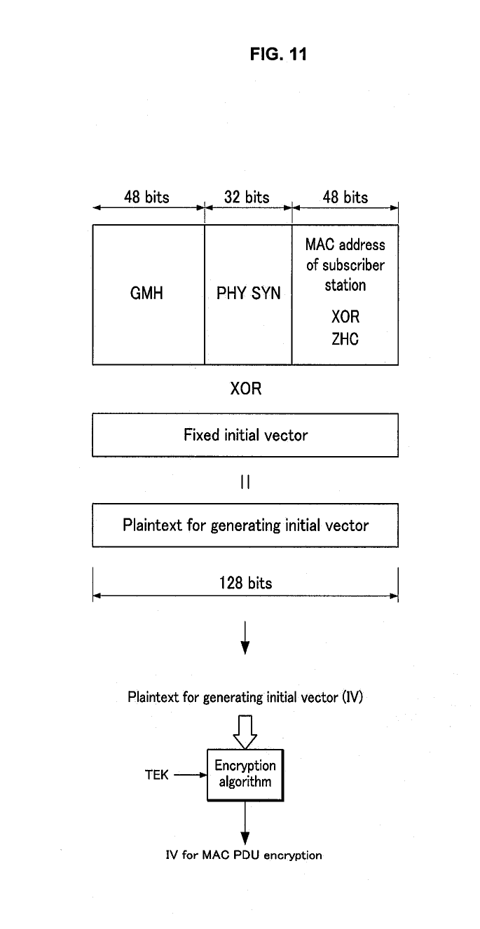

FIG. 10 is a flowchart illustrating a process for generating an initial vector according to the second exemplary embodiment of the present invention, and FIG. 11 exemplary shows initial vector generation according to the process of FIG. 10.

As shown in FIG. 10 and FIG. 11, when a message is input, the initial vector generator 11 of the encryption apparatus 10 determines a frame number from a PHY SYN field, extracts a GMH field from the input message, and determines a MAC address of a corresponding subscriber station of the input message as in the first exemplary embodiment of the present invention.

However, differing from the first exemplary embodiment, the ZHC 16 checks whether the frame number is “0” and increases a count value by a given value when the frame number is “0” after the frame number is determined. At the early stage, the count value of the ZHC is initialized to “0,” and is maintained at “0” during a frame cycle of the corresponding frame number. However, when the frame cycle of the frame number is completed, and thus the frame cycle is repeated, the count value of the ZHC is increased by a predetermined value and thus changed to, for example, “1” in steps S200 to S240.

The initial vector generator 11 first XORs the count value of the ZHC 116 with the MAC address of the subscriber station, and obtains a XORed value in step S250. Then the initial vector generator 11 XORs 1) the XORed result and the frame information (i.e., GMH field information and frame number, excluding the MAC address of the subscriber station) with 2) the fixed initial vector to generate a plaintext for generating an initial vector, that is a initial vector plaintext, in step S260 (see FIG. 11). In this case, the initial vector generator 11 may obtain the XORed value by applying the count value only, instead of the MAC address of the subscriber station.

The initial vector plaintext obtained in the above-described manner is processed with the TEK and output as an initial value IV for encryption, and the output initial value IV is input to the encryption unit 12 in step S270.

Subsequently, the encryption unit 12 encrypts an input plaintext with the initial vector IV and the TEK, and the encrypted plaintext (i.e., ciphertext) is processed MAC frame by MAC frame and transmitted.

The decryption apparatus 20 of the receiving side also generates an initial vector in the same manner as described above, and decrypts a ciphertext of a received frame on the basis of the initial vector.

A count value of the zero hit counter is changed even though frame numbers are repeated by every predetermined cycle and a value of an initial vector is generated with the arbitrary count value and various information. Therefore, a different initial vector can be generated for each different message thereby achieving stable encryption and decryption according to the second exemplary embodiment of the present invention.

In addition, as in the first exemplary embodiment, cryptographic security can be satisfied while efficiently using bandwidth of a transmit frame.

A method for generating an initial vector for encryption and decryption according to a third exemplary embodiment of the present invention will now be described. In the following description, functions that are the same as those of the first and second exemplary embodiments and elements thereof will not be further described.

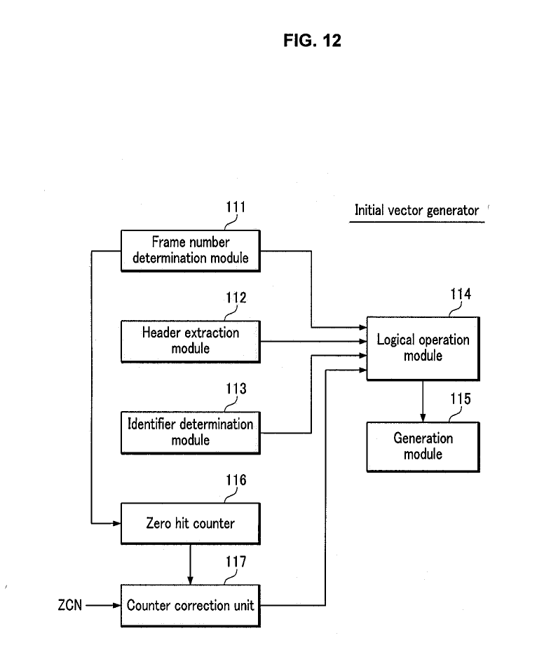

FIG. 12 is a configuration diagram of an initial vector generator according to the third exemplary embodiment of the present invention.

As shown in FIG. 12, similar to the initial vector generator in the second exemplary embodiment, each initial vector generator 11 and 21 according to the third exemplary embodiment of the present invention includes a frame number determination module 111, a header extract module 112, an identifier determination module 113, a logic operation module 114, a generation module 115, and a ZHC 116, but differing from the second exemplary embodiment, the initial vector generators 11 and 21 according to the third exemplary embodiment of the present invention further include a counter correction unit 117 for correcting a count value.

A loss of a broadcast frame may occur due to various causes in the wireless channel. Therefore, when counting the number of zero hits of the object field, e.g., the PHY SYN field, a frame that includes the field may be lost, thereby causing malfunction of the zero hit counter so that the zero hit counter may not be able to count the zero hit.

Therefore, a node (i.e., a base station in the present exemplary embodiment) that broadcasts the PHY SYN field counts how many times a value of the PHY SYN filed is initialized to zero and broadcasts the value at every predetermined point in order to prevent the malfunction of the zero hit counter according to the present embodiment. Such a value that is broadcast from the base station is called “zero cycle number (ZCN).”

An initial vector of the ZCN may be randomly set, and is changed to a predetermined value in accordance with counting of the ZHC. A subscriber station corrects a self-generated value of the ZHC by using the ZCN broadcast from the base station, and uses the corrected value for generating an initial vector for encryption.

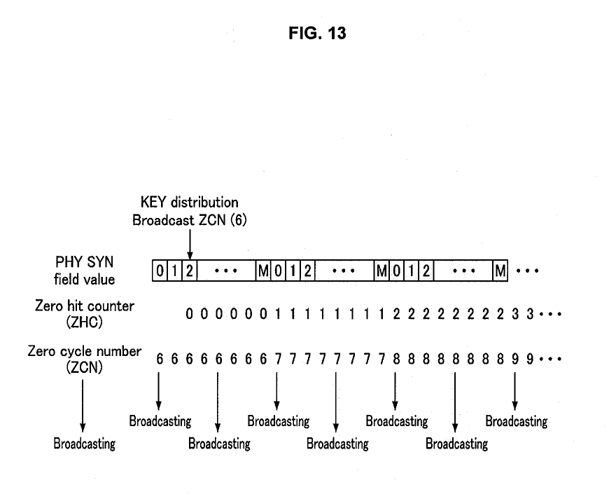

In more detail, the counter correction unit 117 checks the broadcast ZCN, verifies a count value by comparing a count value provided from the ZHC 116 and the ZCN, and selectively corrects the count value according to a result of the verification. FIG. 13 exemplarily illustrates verification and correction functions of the ZHC using the ZCN.

The base station 200 broadcasts a ZCN at every predetermined time, and a frame that distributes the TEK broadcasts the ZCN. Then the counter correction unit 117 of the subscriber station 100 stores a value (e.g., 6) of the broadcast ZCN. The counter correction unit 117 receives a new ZCN broadcast from the base station at every predetermined time, and calculates a difference between the new ZCN (e.g., 7) and the stored ZCN (e.g., 6). A loss of a frame that includes a PHY SYN field is determined by comparing the calculated difference and the count value of the ZHC 116.

In more detail, when a frame number reaches 0 so that the ZCN is changed, a difference between the zero cycle numbers does not have a value of “0”. Therefore, it is determined that the a frame loss occurs when a count value of the ZHC is changed even though the difference between the ZCNs does not have a value of “0”, and the count value of the zero hit counter is changed in accordance with the difference. For example, as shown in FIG. 13, assume that a previous ZCN that has been stored in the counter correction unit 117 has a value of “6” and a count value of the ZHC was estimated to be “0” at that time. When a value of the ZCN that is received at a predetermined point is estimated to be “7,” this implies that the zero hit of the frame number has occurred once after the previous ZCN so that the cycle number that has been broadcast from the base station is changed. However, when the count value of the ZHC is not changed and thus maintains its previous value of “0”, this implies an error has occurred such that the subscriber station could not receive a PHY SYN field of a frame, which includes a frame number.

Therefore, the counter correction unit 117 stores a ZCN and a count value of the ZHC that matches with the ZCN whenever receiving a new ZCN. Also, the counter correction unit 117 determines a frame loss in accordance with a relationship between a first difference between a current ZCN and a previous ZCN, and a second difference between a current count value of the ZHC and a count value of a ZHC that matches with the previous ZCN. Thus, when an error is detected, the counter correction unit 117 corrects the count value of the ZHC based on the first difference.

The initial vector generator generates an initial vector based on a count value that is selectively corrected based on such a ZCN apart from GHM field information, a frame number, and a MAC address of the corresponding subscriber station to prevent the same initial vector from being generated for a different PDU when a frame loss occurs.

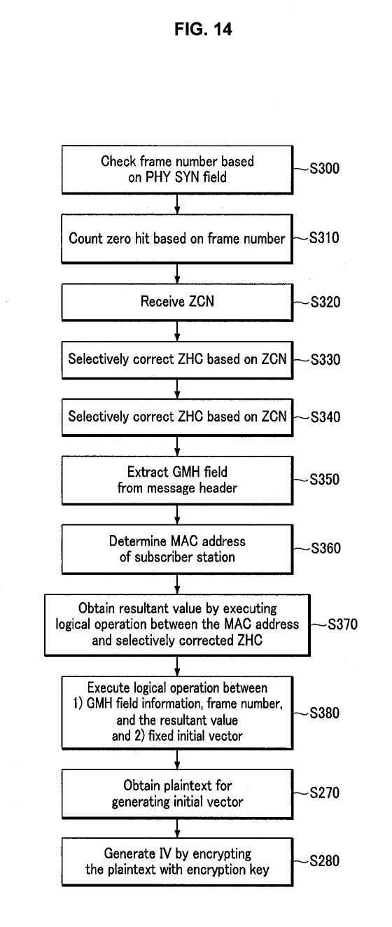

FIG. 14 is a flowchart illustrating a process of generating an initial vector according to the third exemplary embodiment of the present invention.

As shown in FIG. 14, when receiving an input message, the initial vector generator 11 of the encryption apparatus 10 determines a frame number of a PHY SYN field as in the second exemplary embodiment, and the ZHC 116 checks whether the frame number is zero and increases a count value by a predetermined value when the frame number is zero. Otherwise, the count value maintains its previous value, in steps S300 and S310. Subsequently, the counter correction unit 117 selectively corrects the count value of the ZHC based on a broadcast ZCN, in step S330. Then, a GMH field is extracted from the input message and a MAC address of the corresponding subscriber station is determined in steps S340 to S360.

The initial vector generator 11 obtains an XOR value by executing the XOR operation between the selectively corrected count value of the ZHC 116 and the MAC address of the subscriber station, that is an identifier of the subscriber station, and executes the XOR operation between (1) the obtained XOR value and (2) the GMH field information, a frame number, and a fixed initial vector to thereby obtain an initial vector plaintext, in steps S370 to S390. In this case, the initial vector generator 11 may use the count value only as the XOR value rather than applying both of the count value and the MAC address to the XOR operation.

Subsequently, the initial vector plaintext is processed with an encryption key (TEK) and an initial vector IV is generated for encryption, in step S400.

The encryption unit 12 encrypts an input message with the initial vector IV and the TEK and outputs the encrypted message as a ciphertext, and the ciphertext is processed MAC frame by MAC frame and transmitted.

The decryption apparatus 20 of the receiving side also generates an initial vector in the manner described above, and decrypts a ciphertext of a received transmit frame based on the initial vector.

As described, according to the third exemplary embodiment of the present invention, a value of the zero hit counter can be corrected by using the zero cycle number broadcast from the base station even though a frame loss occurs so that a different initial vector can be generated for a different message.

Conventionally, a nonce field is added to a PDU in the typical CCM and CRP modes for recording an initial vector for encryption of each message. A 4-byte nonce field was conventionally used, but the length of the nonce field is reduced to a minimum length and an initial vector is generated by using the reduced nonce field according to a fourth embodiment of the present invention. Such a nonce field that has reduced length is referred to as a “reduced nonce (RN) field.”

The length of the RN field is set to 1 byte according to the fourth exemplary embodiment of the present invention, but it is not restrictive.

In the fourth exemplary embodiment of the present invention, when an RN field is added to a message and the message is transmitted, a transmitting side and a receiving side respectively generate random initial vectors by applying the concept of the zero hit counter to the RN field.

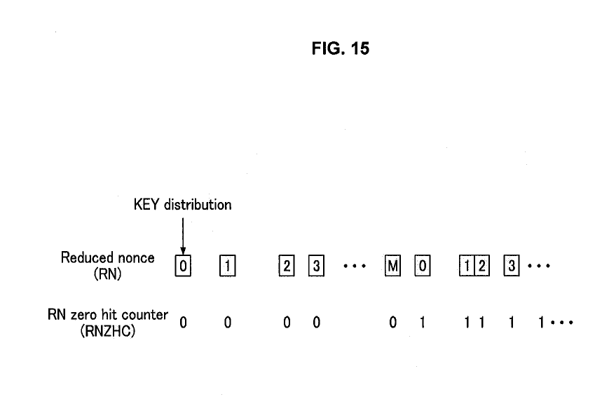

FIG. 15 exemplarily shows a concept of a RN field for generating an initial vector according to the fourth exemplary embodiment of the present invention. A RN field is a field additionally added to each MAC PDU. That is, the RN field is additionally added to each message for recording a random value, and a length of the RN field is less than a conventional length, for example, 4 bytes. For example, assume that the RN field has the length of 1 byte. In this assumption, the RN field has values from 0 to 256, and thus “0” is repeated every 256 values.

Such an RN field may be selectively applied to the first to third exemplary embodiments of the present invention. In this case, assume that an RN field is added to each message in addition to a header field, a data field, and a CRC field in the first to the third exemplary embodiments.

In the case of the first exemplary embodiment, a PHY SYN field may be replaced with an RN field. In this case, the frame number determination module 111 of the initial vector generator 11 determines a random value of the RN field. Therefore, the initial vector generator 11 generates an initial vector for encryption by using GMH field information of the message, a MAC address of a subscriber station which is selectively used, and the random value of the RN field that replaces a frame number of a PHY SYN field, and encrypts and decrypts a message.

In addition, in the case of applying the RN field, the concept of the zero hit counter may be applied as in the second exemplary embodiment to correct repetition of the values of the RN field to thereby increase an initial vector variation cycle. In this case, the zero hit counter counts the number of times that a value of the RN field is “0” rather than counting the number of zero hits of the PHY SYN field. At this time, the zero hit counter is operated as a reduced number zero hit counter (RNZHC). Then the initial vector generator generates an initial vector for encryption by using the value of the RN field, the count value, GMHG field information of the message, and a MAC address of the subscriber station as in the second exemplary embodiment, and decrypts or encrypts the message. Herein, the MAC address of the subscriber station may be selectively used.

When a frame loss occurs due to application of the zero cycle number to the value of the RN field, as in the third exemplary embodiment of the present invention, a count value of the RN field may be corrected.

As described, when the concept of the RN field in the fourth exemplary embodiment is applied to the first to third exemplary embodiments of the present invention, the PHY SYN field may be partially used as the RN field. For example, when the PHY SYN field has a length of 4 bytes, 1 byte is used for the RN field to record a random value for generating an initial vector.

In addition, when the RN field of the fourth exemplary embodiment is applied to the third exemplary embodiment, the PHY SYN field may be used as the RN field and an RNZHC field for recording a count value to correct a value of the RN field. That is, a value of the RN field also has the same value at every predetermined cycle, and therefore the value needs to be corrected. Therefore, in order to correct the value of the ZCN of the third exemplary embodiment and the value of the RN field, the base station may count the random value recorded in the RN field and broadcast a random cycle number. In this case, the PHY SYN field may be replaced with the RN field and the RNZHC field. For example, when the PHY SYN field has a length of 4 bytes, the RN field may have a length of 1 byte and the RNZHC field may have a length of 3 bytes.

Instead of replacing the PHY SYN field with the RN field in the first to third exemplary embodiments of the present invention, an initial vector may be generated by using both fields. That is, a frame number of the PHY SYN field, a random value of the RN field, GMH field information, and a selectively used MAC address of the subscriber station can be used for generating the initial vector.

For example, in the first exemplary embodiment, the frame number of the PHY SYN field and the random value of the RN field are XORed to obtain a predetermined XORed value. Then, the XORed value, the GMH field information, and the selectively used MAC address of the subscriber station are XORed with the fixed initial vector to obtain an initial vector plaintext, and the initial vector plaintext is encrypted with the encryption key so that an initial vector for encryption is obtained.

In addition, in the second exemplary embodiment, the repetition of the values of the RN field and the frame numbers can be compensated by equally applying the concept of the zero hit counter to the RN field and the frame number. In this case, the count value of the zero hit counter may be divided into a first count value that represents the number of zero hit times of the RN field and a second count value that represents the number of zero hit times of the frame number. Therefore, the initial vector generator may generate an initial vector for encryption by using the first and second count values, GMH field information of a message, and a selectively used MAC address of the subscriber station, as in the second exemplary embodiment of the present invention.

When both a frame number of the PHY SYN field and a random value of the RN field are applied to the third exemplary embodiment, a count value of the RN field and a count value of the frame number may be corrected on the basis of the zero cycle number so as to generate an initial vector for encryption.

A person of an ordinary skill in the art is able to selectively apply the RN field of the fourth exemplary embodiment to the first to third exemplary embodiments based on the above-described first to third embodiments of the present invention, and therefore detailed descriptions thereof will be omitted.

In addition, the identifier (i.e., MAC address) of the subscriber station is used for generating an initial vector according to the first to fourth exemplary embodiments of the present invention, but it may not be used for generating the initial vector for encryption.

The above-described encryption, decryption, and initial vector generation methods may be implemented as a program that can be stored in a computer-readable recording medium. The recording medium may include all types of recoding apparatuses that record data that a computer can read, for example, a CD-ROM, a magnetic tape, and a floppy disk. The recording medium may also be provided as a carrier wave (e.g., transmission through the Internet).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### INDUSTRIAL APPLICABILITY

The above-described embodiments of the present invention provide the following advantages:

First, a transmitting side and a receiving side can respectively generate an initial vector for encryption and decryption even though information for encryption is not additionally transmitted/received in a wireless portable Internet system. Therefore, the size of a transmit message frame can be reduced, thereby enhancing bandwidth usage efficiency.

Second, an initial vector for an encryption function is generated for each message, and therefore the size of a random field that records additional information for the encryption can be minimized.

Third, a different initial vector is generated for each different message, thereby satisfying a minimum requirement of an encryption algorithm for cryptographic security.

Fourth, the probability of generating the same initial vector for different messages can be reduced by using the zero hit counter, and more particularly, this probability can be significantly reduced compared to a conventional 4-byte nonce field.

Fifth, the probability of an error occurrence can be reduced by correcting a value of the zero hit counter with the zero cycle number.

Sixth, although a nonce field that is significantly smaller than the conventional 4-byte nonce field is used, an initial vector variation cycle can be significantly increased by applying the zero hit counter, thereby significantly reducing the probability of generating the same initial vector for different messages.

1. A method for generating an initial vector for encryption/decryption of a message transmitted/received between a subscriber station and a base station in a wireless portable Internet system, the subscriber station and the base station sharing an encryption key through key distribution, the method comprising:
a) obtaining first information shared by the subscriber station and the base station in a wireless channel;
b) extracting predetermined second information from the message; and
c) generating the initial vector on the basis of one of the first and second information.

2. The method of claim 1, wherein the first information comprises a frame number that is broadcast for each frame and, in c), the initial vector is generated on the basis of the frame number.

3. The method of claim 2, wherein the second information is header information included in the message and, in c), the initial vector is generated on the basis of the frame number and the header information.

4. The method of claim 3, wherein the subscriber station and the base station share an encryption key and a fixed initial vector through key distribution, and
c) comprises:
obtaining an initial vector plaintext by executing a logical operation between 1) the frame number and the header information and 2) the fixed initial vector; and
generating the initial vector by processing the initial vector plaintext with the encryption key.

5. The method of claim 3, wherein the first information further comprises a count value that represents the number of zero hit times of the frame number, and in c), the initial vector is generated on the basis of the frame number, the header information, and the count value.

6. The method of claim 5, wherein the first information further comprises a zero cycle number that represents the number of zero hit times of the frame number counted and broadcast by the base station, and,
c) comprises:
selectively correcting the count value based on the zero hit cycle; and
generating the initial vector based on the frame number, the header information, and the selectively corrected count value.

7. The method of claim 5 or claim 6, wherein the subscriber station and the base station share an encryption key and a fixed initial vector during key distribution, and
c) comprises:
obtaining a resultant value by executing a logical operation on the count value;
obtaining an initial vector plaintext by executing the logical operation between 1) the frame number, the header information, and the resultant value and 2) the fixed initial vector; and
generating the initial vector by processing the initial vector plaintext with the encryption key.

8. The method of anyone of claim 2 to claim 6, wherein the second information further comprises an identifier of the subscriber station, and
when generating the initial vector in c), the identifier of the subscriber station is additionally used.

9. The method of claim 1 or claim 2, wherein the message comprises a reduced nonce field that includes a predetermined random value, and the second information comprises the random value, and
in c), the initial vector is generated by using the random value of the reduced nonce field.

10. The method of claim 9, wherein the second information further comprises a count value that represents the number of zero hit times of the random value of the reduced nonce field, and
when generating the initial vector in c), the count value is additionally used.

11. The method of claim 10, wherein the first information further comprises a zero cycle number which is the number of zero hit times counted and broadcast by the base station, and
c) comprises:
selectively correcting the count value based on the zero cycle number; and
generating the initial vector based on the frame number, the header information, and the selectively corrected count value.

12. The method of claim 1 or claim 2, wherein the first information is information recorded in a PHY SYN field that is broadcast for each frame, and the PHY SYN field comprises a first field recording a random value and a second field recording a zero cycle number which represents the number of zero hit times of the random number.

13. The method of claim 12, wherein the first information further comprises a count value that represents the number of zero hit times of the random value of the first field, and
c) comprises:
selectively correcting the count value according to a random cycle number of the second field; and
generating the initial vector by using the random value and the count value.

14. The method of claim 6, wherein the correcting of the count value comprises:
calculating a first difference between a zero cycle number that is currently obtained and a zero cycle number that was previously obtained;
calculating a second difference between a current count value and a previous count value; and
correcting the count value according to a relationship between the first difference and the second difference.

15. A method for generating an initial vector required for encryption/decryption of a message transmitted/received between a subscriber station and a base station in a wireless portable Internet system, the subscriber station and the base station sharing an encryption key during key distribution, the method comprising:
a) determining a frame number that is broadcast for each frame;
b) extracting a header from the message and determining header information;
c) determining an identifier of the subscriber station; and
d) generating an initial vector for encryption on the basis of the frame number, the header information, and the identifier of the subscriber station.

16. The method of claim 15, wherein the subscriber station and the base station additionally share a fixed initial vector during the key distribution, and
d) comprises:
obtaining an initial vector plaintext by executing a logical operation between 1) the frame number, the header information, and the identifier and 2) the fixed initial vector; and
generating the initial vector by processing the initial vector plaintext with the encryption key.

17. A method for generating an initial vector for encryption/decryption of a message transmitted/received between a subscriber station and a base station in a wireless portable Internet system, the subscriber station and the base station sharing an encryption key during key distribution, the method comprising:
a) determining a frame number that is broadcast for each frame;
b) extracting a header from the message and determining header information;
c) determining an identifier of the subscriber station;
d) obtaining a count value that represents the number of zero hit times of the frame number; and
e) generating an initial vector for encryption based on the frame number, the header information, the identifier, and the count value.

18. The method of claim 17, wherein the subscriber station and the base station additionally share a fixed initial vector during the key distribution, and
e) comprises:
executing a logical operation between the identifier and the count value and obtaining a resultant value of the execution;
obtaining an initial vector plaintext by executing a logic operation between 1) the frame number, the header information, and the resultant value and 2) the fixed initial vector; and
generating the initial vector by processing the initial vector plaintext with the encryption key.

19. The method of one of claim 3, claim 15, and claim 17, wherein the header information is at least one information among the information that form a generic message header (GMH) field.

20. The method of claim 19, wherein, in the GMG field, the header information is information on a length field for representing a length of a message and a header check sum (HCS) field for checking an error in a message header.

21. An encryption apparatus for encrypting a message transmitted/received between a subscriber station and a base station in a wireless portable Internet system, the subscriber station and the base station sharing an encryption key during key distribution, the encryption apparatus comprising:
an initial vector generator for generating an initial vector for encryption of the message based on information shared by the subscriber station and the base station; and
an encryption unit for encrypting the message with the initial vector and the encryption key.

22. The encryption apparatus of claim 21, wherein the initial vector generator comprises:
a determination module for determining a value of a predetermined object field;
a header extract module for extracting a header portion of an input message; and
a generation module for generating an initial vector for encryption based on the determined value of the object field and the extracted header information of the message.

23. The encryption apparatus of claim 22, further comprising a zero hit counter for obtaining a count value that corresponds to the number of zero hit times of the value of the object field.

24. The encryption apparatus of claim 23, further comprising a counter correction unit for obtaining a zero cycle number that is generated from the base station and selectively correcting the count value based on the zero cycle number.

25. The encryption apparatus of one of claim 22 to claim 24, wherein the initial vector generator further comprises an identifier determination module for determining an identifier of an object of the message, and
the generation module generates the initial vector for encryption by additionally using the identifier.

26. The encryption apparatus of one of claim 22 to claim 24, wherein the object field represents a frame number that is broadcast from the base station for each frame.

27. The encryption apparatus of one of claim 22 to claim 24, wherein the object field is a reduced nonce field that is added to the message.

28. The encryption apparatus of one of claim 22 to claim 24, wherein the object field is a physical layer (PHY) synchronization (SYN) field that is broadcast for each frame, and the PHY SYN field comprises a first field that includes a random value and a second field that records a zero cycle number which represents the number of zero hit times of the random value.

29. A decryption apparatus for decrypting a message transmitted/received between a subscriber station and a base station in a wireless portable Internet system, the subscriber station and the base station sharing an encryption key during key distribution, the decryption apparatus comprising:
an initial vector generator for generating an initial vector for decryption of the message based on information shared by the subscriber station and the base station in a wireless channel; and
a decryption unit for decrypting the message with the initial vector and the encryption key, wherein
the generated initial vector corresponds to an initial vector used for encryption of the message.

30. The decryption apparatus of claim 29, wherein the initial vector generator comprises:
a determination module for determining a value of a predetermined object field;
a header extract module for extracting a header portion of an input message; and
a generation module for generating an initial vector for decryption based on the determined value of the object field and information on the extracted header of the message.

31. The decryption apparatus of claim 30, further comprising a zero hit counter for obtaining a count value that represents the number of zero hit times of the value of the object field.

32. The decryption apparatus of claim 31, further comprising a counter correction unit for obtaining a zero cycle number generated from the base station and selectively correcting the count value based on the zero cycle number.

33. The decryption apparatus of one of claim 29 to claim 32, wherein the initial vector generator further comprises an identifier determination module for determining an identifier for an object of the message, and
the generation module generates the initial vector by additionally using the identifier.

34. The decryption apparatus of one of claim 29 to claim 32, wherein the object field is a frame number that is broadcast from the base station for each frame and a reduced nonce field included in the message, and the object field is one of the PHY SYN fields that are broadcast for each frame, the PHY SYN fields comprising a first field that includes a random value and a second field that records a zero cycle number that represents the number of zero hit times of the random value.
